(19) United States
(12) Patent Application Publication
(10) Pub. No.: US 2007/0144589 A1
(43) Pub. Date: Jun. 28, 2007

(54) Flow conrol valve for a gas combustion device

(76) Inventor: I-Hua Huang, Taipei City (TW)

Correspondence Address: BACON & THOMAS, PLLC, 625 SLATERS LANE, FOURTH FLOOR, ALEXANDRIA, VA, 22314, US

(21) Appl. No.: 11/313,728

(22) Filed: Dec. 22, 2005

(51) Int. Cl. F16K 31/02

(52) U.S. Cl. 137/601.14; 137/601.15

(57) ABSTRACT

A flow control valve for a gas combustion device, it comprises: a main-valve plug rod, a main-valve plug, a flow adjusting stick and a valve main-body; the valve main-body is provided with a main valve port in opposition to and cooperation with the main-valve plug to form the functions of sealing and opening the main valve port. The outlet of the main valve port has downstream of it two sections of space having therebetween a section difference, an end of an outlet of the two sections of space is a flow control hole with a smaller caliber and in opposition to and cooperation with the flow adjusting stick on the main-valve plug rod to provide a flow limiting function. A small flow complementing hole is provided in the two sections of space in communication with the flow control hole; by adjusting with a micro-adjusting screw, different amounts can be complemented for flow control and adjusting.

### BACKGROUND OF THE INVENTION

1. Field of the Invention

The present invention is related to a flow control valve for a gas combustion device, and especially to a flow control structure on the inlet end of the gas combustion device, the structure has a plurality of functions including section-difference control and flow adjusting etc., and is suitable particularly for use of a gas stove or other gas combustion devices in need of flow control.

2. Description of the Prior Art

Gas combustion devices are widely used heat generating devices in modern societies, of which for instance, gas stoves, gas supplied water heaters, high flow fast stoves, industrial ovens etc. are most often seen.

However, flow of gas for combustion required will be different in pursuance of different natures of utility, places, or when a gas combustion device is used in different cases; stoves in present days always have safety devices for flow control or timing devices for cooking and for setting times conveniently. For example, flow control with emergency interruption can prevent possible accidents; or amount of supplying of gas for combustion can be changed by electronic controlling to make fire in a stove changed to be smaller or terminated according to time predetermined. And thereby, flow control valves suitable for the states of using shall be provided at upper streams of gas supplying ends of various gas combustion devices to give gas for combustion in amounts meeting what are required.

Normal flow control valves are specifically manufactured in pursuance of corresponding gas combustion devices, they have low mutual adaptability industrially, and they may have different requirement for amount of flow even if they are gas combustion devices of similar appearances or features. For example, a stove set includes a plurality of stoves, each stove can have different requirement for power although they commonly use a gas source.

For this reason, various flow control valves each will present its own flow supplying state or shall have its own set values of section flows in coincidence with its own stove; particularly, in the recent years, electronic gas combustion devices are more required in accurately setting amount of flows to meet automation settings that are safer and more humanized. While conventional flow control techniques performing by changing calibers of flow pipes or by providing plural given calibers for changing are not so easy to carry out in site, to change or adjust, hence are unable to do accurate micro-adjustment according to the requirement of changing in use.

### SUMMARY OF THE INVENTION

In view of the above stated problems of the conventional techniques, the gist of the present invention is to design a flow control valve widely applicable to various gas combustion devices for fast and accurate micro-adjustment according to the requirement in use.

The flow control valve for a gas combustion device of the present invention comprises: a main-valve plug rod displacing linearly, a main-valve plug provided at the middle section of the main-valve plug rod, a conical flow adjusting stick provided on the front end of the main-valve plug rod and able to synchronically displace linearly with the main-valve plug rod, and a valve main-body which is provided with a main valve port having a sealing function in opposition to and cooperation with the main-valve plug on the main-valve plug rod to form the functions of sealing and opening the main valve port.

The outlet of the main valve port is provided at a location downstream of it with two sections of space having therebetween a section difference, an outlet of the two sections of space is a flow control hole with a smaller caliber, the flow control hole is in opposition to and cooperationwith the flow adjusting stick on the main-valve plug rod to provide a flow limiting function that adjusts the flow at the outlet.

Wherein the present invention is further provided in the two sections of space having therebetween a section difference with a small flow complementing hole in communication with the flow control hole; by adjusting with a micro-adjusting screw, different amounts can be complemented for the outlet downstream of the flow control hole.

Accordingly, the flow control valve for a gas combustion device of the present invention can give an effect of multiple-section flow control, and can carry out adjustment in the mode of flow limiting according to the requirement in use, so that the flow control valve can obtain an accurate flow control effect, and can be advantageously used on an electronically controlled gas combustion device such as: an electronically controlled gas stove, a microcomputer gas stove etc.

Certainly, the mode that the main-valve plug rod displaces is carried out by a driving set through providing of a connecting member, the connecting member is extended into the valve main-body to push the main-valve plug rod to displace linearly, but the main-valve plug rod is kept an airtight separation state from a motor and the valve main-body.

The present invention will be apparent in its mode of operation according to its technical measures after reading the detailed description of the preferred embodiment thereof in reference to the accompanying drawings.

### BRIEF DESCRIPTION OF THE DRAWINGS

FIG. 1 is a sectional schematic view showing a first action of a first embodiment of the present invention;

FIG. 2 is a sectional schematic view showing a second action of the first embodiment of the present invention;

FIG. 3 is a sectional schematic view showing a third action of the first embodiment of the present invention;

FIG. 4 is a sectional schematic view showing the operation of adjustment of the first embodiment of the present invention;

FIG. 5 a sectional schematic view of a second embodiment of the present invention;

FIG. 6 is a sectional schematic view of a third embodiment of the present invention;

FIG. 7 a sectional schematic view of a fourth embodiment of the present invention;

FIG. 8 is a sectional schematic view of a fifth embodiment of the present invention;

FIG. 9 is a sectional schematic view of a sixth embodiment of the present invention;

FIG. 10 is a sectional schematic view of a seventh embodiment of the present invention.

### DETAILED DESCRIPTION OF THE PREFERRED EMBODIMENT

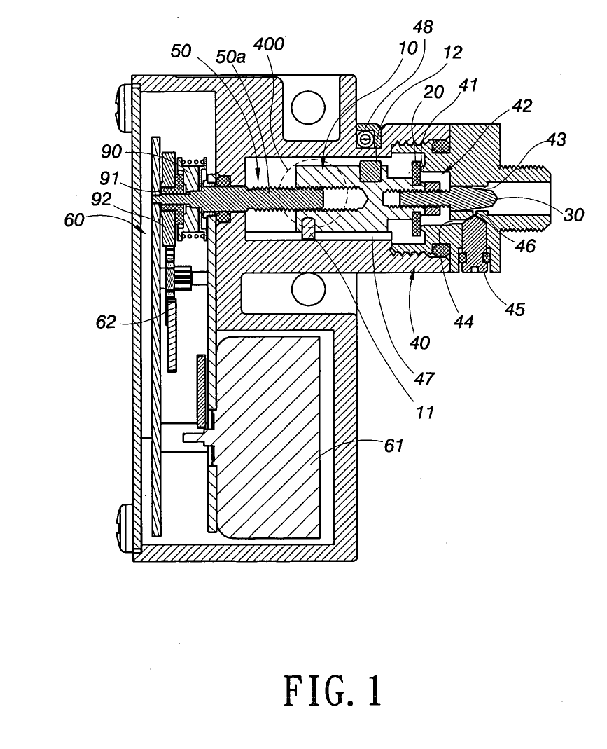

FIG. 1 is a sectional schematic view showing a first embodiment of the present invention, in this embodiment, the flow control valve for a gas combustion device comprises: a main-valve plug rod 10 displacing linearly, a main-valve plug 20 provided at the middle section of the main-valve plug rod 10, a conical flow adjusting stick 30 provided on the front end of the main-valve plug rod 10 and able to synchronically displace linearly with the main-valve plug rod 10, a valve main-body 40 (which can be composed of a plurality of components), a connecting member 50 for moving the main-valve plug rod 10 and a driving set 60 for driving the connecting member 50.

The valve main-body 40 has a gas outward-supplying main valve port 41 having a sealing function; the main valve port 41 is in opposition to and cooperation with the main-valve plug 20 on the main-valve plug rod 10 to form the functions of sealing and opening the main valve port 41. The valve main-body 40 is provided with a communication hole 400 for entering of gas for combustion which is unable to be seen in the drawing because of the angle of sight, a dotted line is depicted to express this; when the gas for combustion flows, it enters the valve main-body 40 via the communication hole 400, and then flows out of the valve main-body 40.

The downstream area of the main valve port 41 is provided with two sections of space 42 having therebetween a section difference, an end of an outlet of the two sections of space 42 is a flow control hole 43 with a smaller caliber, the flow control hole 43 is in opposition to and cooperation with the flow adjusting stick 30 on the main-valve plug rod 10 to provide a flow limiting function that adjusts the flow to the end of the outlet.

The two sections of space 42 having therebetween the section difference is further provided therein with a small flow complementing hole 44 in communication with the flow control hole 43; by adjusting with a micro-adjusting screw 45, different amounts can be complemented for the flow control hole 43.

The main-valve plug rod 10 is driven by a driving set 60 through providing of the connecting member 50, the connecting member 50 is extended into the valve main-body 40 to push the main-valve plug rod 10 to displace linearly; such designing renders the driving set 60 to keep an airtight separation state from the main-valve plug rod 10, and the driving set 60 has a power supplying motor 61 to drive the connecting member 50 by cooperation with a gearing mechanism 62.

In the first embodiment of the present invention, the connecting member 50 is a link 50a rotating by moving of the driving set 60, the link 50a is screw connected with the main-valve plug rod 10; and the main-valve plug rod 10 cooperates with the valve main-body 40 in a mode of being guided for to and fro moving without rotating; for example, as is disclosed in the drawing, a slide key 11 cooperates with a slide groove 47 to get the mode of being guided. Thereby, when the link 50a is rotated, the main-valve plug rod 10 can do linear displacement in the valve main-body 40. Further, the main-valve plug rod 10 is provided with a position detecting magnetic stone 12, the valve main-body 40 is provided at a position in opposition to that of the position detecting magnetic stone 12 with a displacement detecting element 48 to detect the relative position of the position detecting magnetic stone 12 to obtain the displacement of the main-valve plug rod 10 and the state of opening/closing of the main valve port 41.

Additionally, the above mentioned flow adjusting stick 30 is fixed on the main-valve plug rod 10 with screws and nuts, so that the flow adjusting stick 30 can be adjusted on its acting distance from the flow control hole 43 to do adjustment according to the requirement of gas for combustion.

The above mentioned gearing mechanism 62 of the driving set 60 further includes a clutch which has an active wheel 92, a passive wheel 90 and a friction rubber member 91; the passive wheel 90 is fixed on a clutch plate, the friction rubber member 91 is a rubber collar, the active wheel 92 is a gear of a retarding mechanism. When a downstream load is smaller than the friction, the active wheel 92 can move the passive wheel 90 for synchronic rotation, but when the load is larger than the friction, the active wheel 92 slides away from the passive wheel 90.

The above stated FIG. 1 is a schematic view showing a first action of a first embodiment of the present invention, it shows a state that the main-valve plug rod 10 is pushed by the connecting member 50 to a condition that the main-valve plug 20 completely seals the main valve port 41; at this time, the flow adjusting stick 30 also seals the flow control hole 43; the flow adjusting stick 30 is connected with the main-valve plug rod 10 by means of screws and nuts, thus it can be used to adjust the degree of connecting of it with the main-valve plug rod 10.

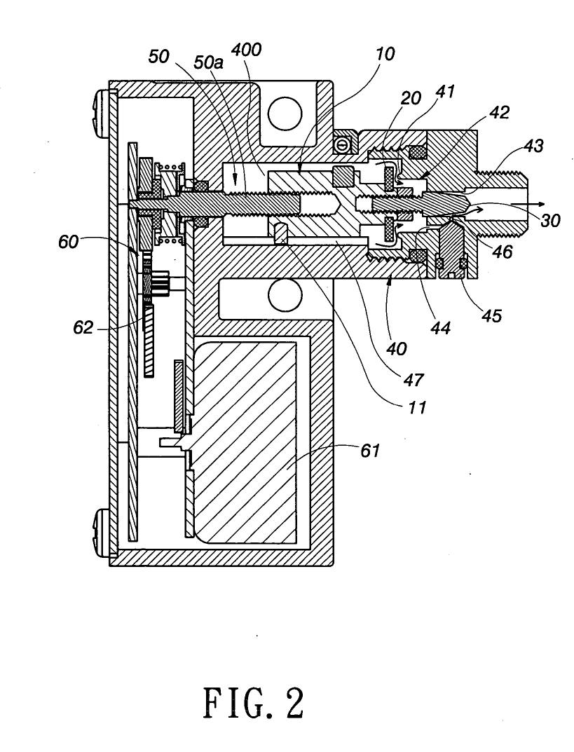

FIG. 2 is a sectional schematic view showing a second action of the first embodiment of the present invention, when the main-valve plug rod 10 is pulled by the connecting member 50 to the left, the main-valve plug 20 slightly opens the main valve port 41, now the flow adjusting stick 30 still limits the flow at the flow control hole 43, however, partial gas for combustion can already leak out of the flow control hole 43 through an outlet 46.

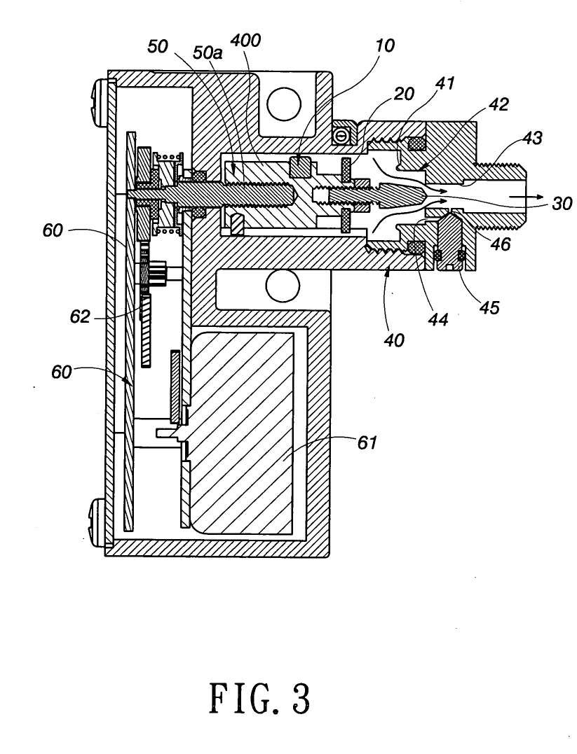

FIG. 3 is a sectional schematic view showing a third action of the first embodiment of the present invention, when the main-valve plug rod 10 is pulled by the connecting member 50 completely to the left, the main-valve plug 20 completely opens the main valve port 41, now the flow adjusting stick 30 more opens the flow control hole 43, and partial gas for combustion still leaks out of the flow control hole 43 through the outlet 46.

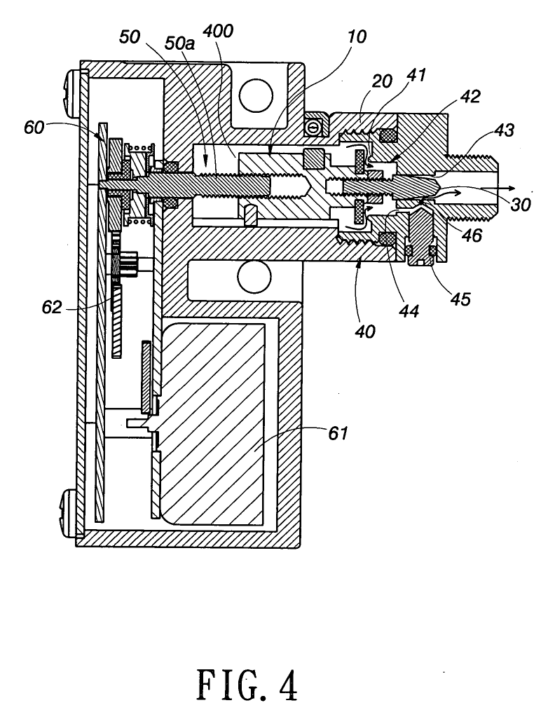

FIG. 4 is a sectional schematic view showing the operation of adjustment of the first embodiment of the present invention; in addition to the above stated actions, the present invention is characterized in the design of providing the small flow complementing hole 44 and the micro-adjusting screw 45; as is shown in the drawing, when the micro-adjusting screw 45 is rotated, it influences the flow of the flow control hole 43 to generate various flow complementing effects (a comparison can be made between FIG. 4 and FIG. 1).

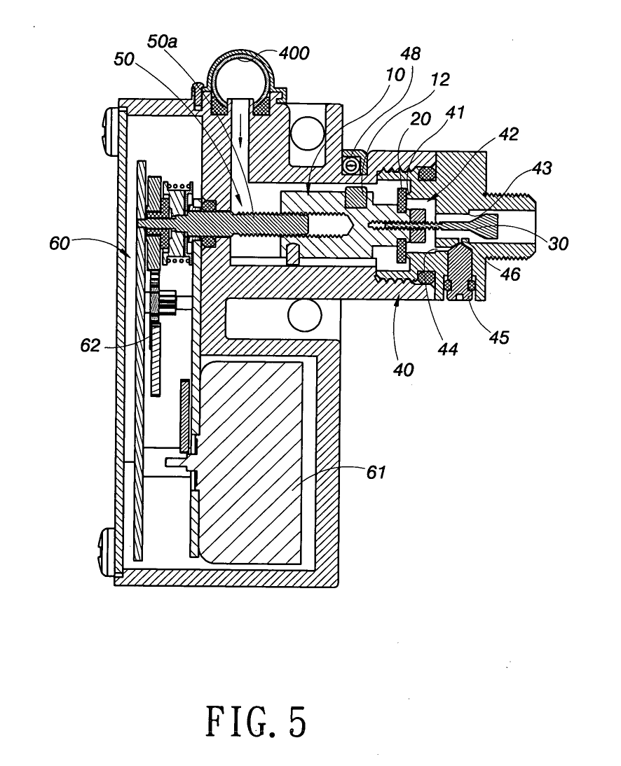

As shown in FIG. 5 being a sectional schematic view of a second embodiment of the present invention, this second embodiment is same structurally as the first embodiment but with a difference in that: the area that the communication hole 400 is provided at and the shape that the flow adjusting stick 30 is are different; the flow adjusting stick 30 can have a different shape that cooperates with the linear displacement of the main-valve plug rod 10 to provide different gas supplying variations for different requirements of use.

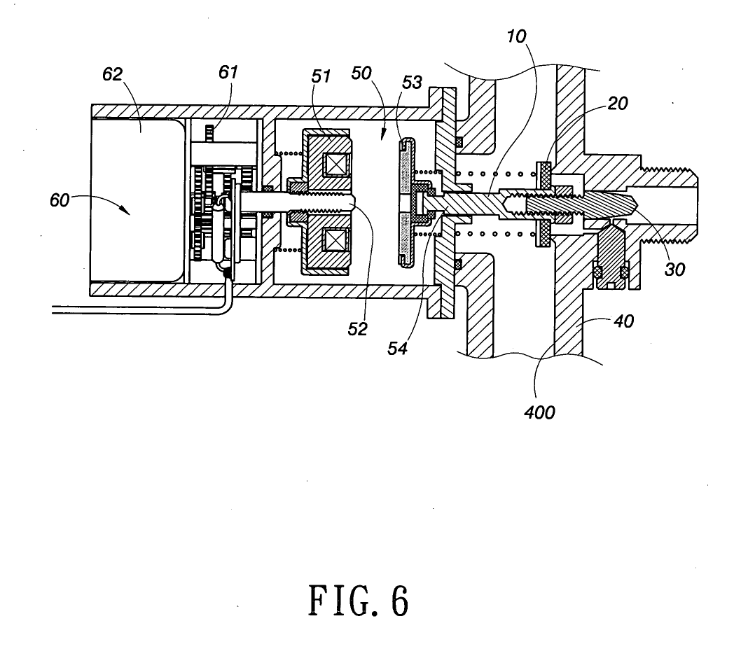

As shown in FIG. 6 being a sectional schematic view of a third embodiment of the present invention, this embodiment is same structurally as the first embodiment but with a difference in that: the connecting member 50 is an electromagnetic linkage driven by the driving set 60, the electromagnetic linkage includes an acting rod 51 moved by the driving set 60 for rotation, an electromagnetic disk 52 screw connecting with the acting rod 51 and displacing linearly to and fro, and an induction disk 53 provided in opposition to the electromagnetic disk 52 is influenced by the latter to generate linear displacement, the induction disk 53 has a pusher rod 54 in connecting with the main-valve plug rod 10 to make the main-valve plug rod 10 displace linearly in the valve main-body 40; certainly, the third embodiment can also cooperates with the communication hole 400 to allow communication of gas for combustion with the outside of the valve main-body 40, for example: a parallel connection of a plurality of flow control valves can be formed by providing the communication hole 400.

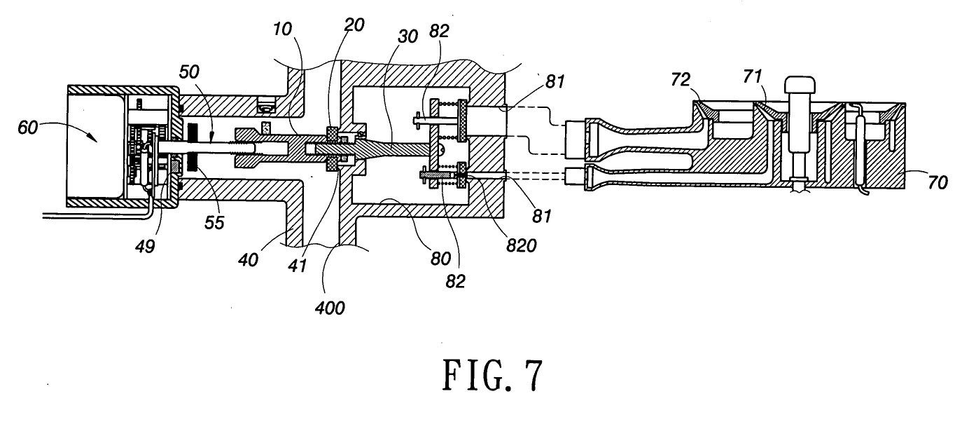

As shown in FIG. 7 being a sectional schematic view of a fourth embodiment of the present invention, this embodiment is same structurally as the first embodiment but with a difference in that: the main-valve plug rod 10 is provided outside of the main valve port 41 with a diversion chamber 80 having a plurality of diversion holes 81 with different diameters. And the flow adjusting stick 30 is provided on its front end with a plurality of diversion control plugs 82 mating with the diversion holes 81, the diversion control plugs 82 and their corresponding diversion holes 81 have their respective set distances in order that the diversion holes 81 have different closing and opening times when the flow adjusting stick 30 displaces linearly, such as is disclosed in the drawing, the designing of diversion makes separation of an inner orifice 71 of a stove 70 from an outer orifice 72, thereby supplying gas for combustion in the mode of diversion can be practiced; and a minimum flow hole 820 can be provided on a valve plug-axle of the diversion control plugs 82 to keep a flame un-extinguished.

Moreover, a speed detecting magnetic stone 55 can be provided on the connecting member 50, and the valve main-body 40 is provided at a position in opposition to that of the speed detecting magnetic stone 55 with a rotating rate detecting element 49 to detect the rotating frequency of the connecting member 50 driven by the driving set 60, hence the state of operation of the driving set 60 can further be controlled.

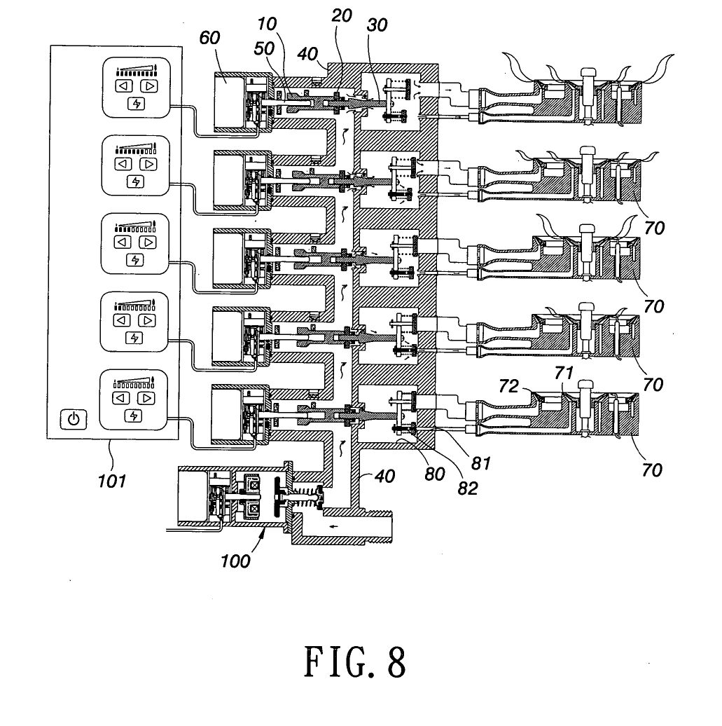

As shown in FIG. 8 being a sectional schematic view of a fifth embodiment of the present invention, this embodiment is same by principle as the fourth embodiment, a plurality of flow control valves are parallelly connected for gas combusting of a plurality of stoves 70; and a master control valve 100 can be provided to do supplying control on upstream gas for combustion for all the flow control valves; and more, driving sets 60 in cooperating with the flow control valves can be integrated and controlled with a control panel 101, and ignitions of all the stoves 70 are made to render gas supplying more convenient for operation of a user.

Additionally, FIG. 8 further discloses the relationship between the diversion holes 81 and diversion control plugs 82, with the relationship, the modes of ignitions of their inner orifices 71 and their outer orifices 72 can have various changes, for example: the inner orifices 71 and the outer orifices 72 are all in the extinguished state, or only the inner orifices 71 have small tongues of fire, or the inner orifices 71 and the outer orifices 72 all have small fires, or the inner orifices 71 and the outer orifices 72 all have large fires.

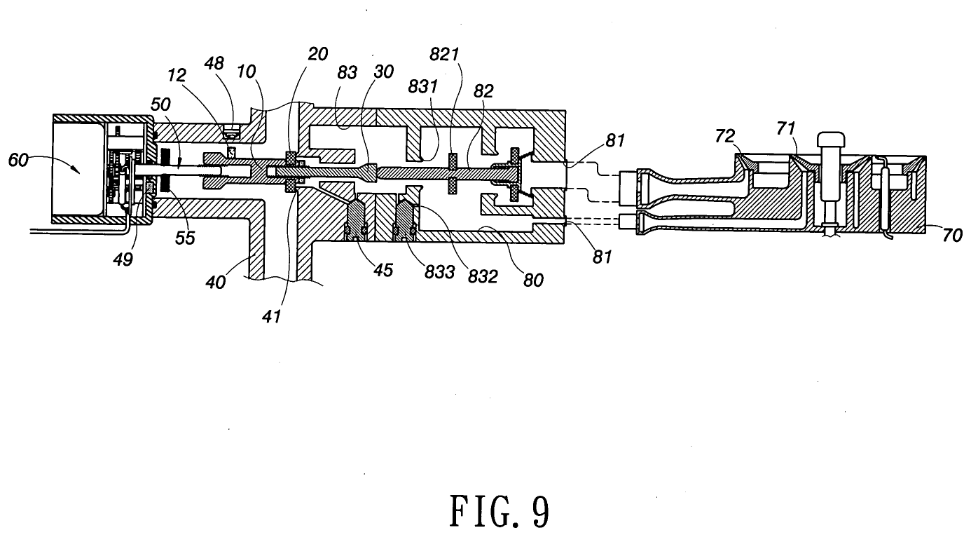

As shown in FIG. 9 being a sectional schematic view of a sixth embodiment of the present invention, this embodiment is same by principle as the fifth embodiment, however, in order to render the designing of a diversion chamber 80 and a plurality of diversion holes 81 to make richer effects of gas supplying, and to prevent the problem of extinguishing because of inadequate gas supplying under some situations of use when the gas combustion device is in burning with small fires.

Consequently, a front diversion chamber 83 can be provided between the main valve port 41 and the diversion chamber 80, a second valve port 831 can be provided between the front diversion chamber 83 and the diversion chamber 80, and a diversion control plug 82 can be provided thereon with a second valve plug 821 to cooperate with the second valve port 831 to give a function of opening/closing.

The front diversion chamber 83 further is provided with a by-pass minimum flow hole 832 to communicate with the diversion chamber 80, the minimum flow hole 832 is provided thereon with a second micro-adjusting screw 833 for adjusting flow in order that the gas for combustion flows out from the minimum flow hole 832, and the gas for combustion flowing out from the minimum flow hole 832 can be supplied through a normally opening diversion hole 81 for the gas combustion device for prime combustion; thereby when the main valve port 41 is opened, the flow control valve of the present invention can still provide for the gas combustion device most prime flow of gas for combustion no matter the second valve port 831 is opened or not; thus the gas combustion device can be prevented from extinguishing when it is operated with a minimum flame.

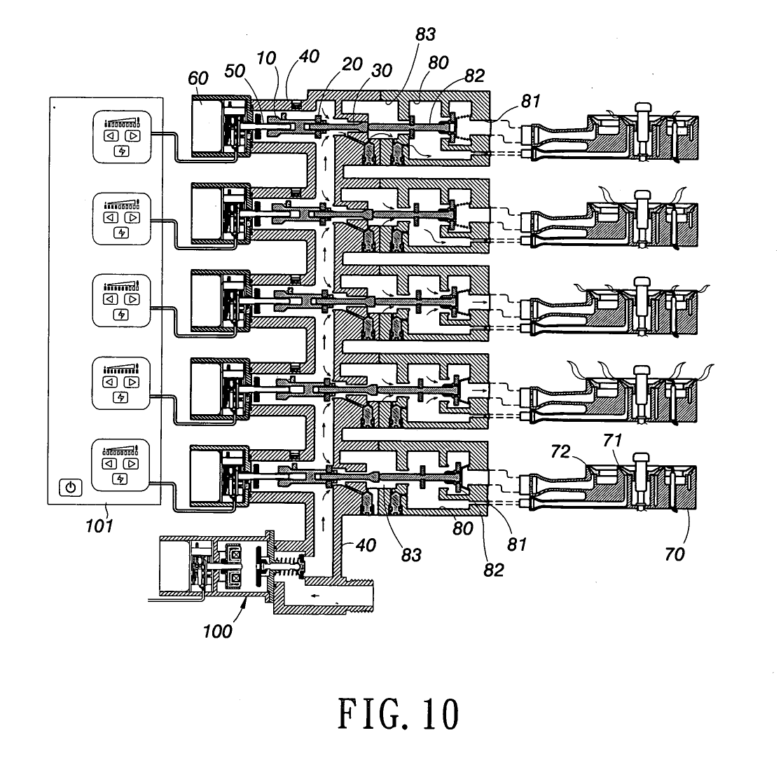

FIG. 10 is a sectional schematic view of a seventh embodiment of the present invention; it provides a parallel connection for a plurality of flow control valves of FIG. 6; by providing a master control valve 100 and a control panel 101 to make control of the gas combustion device (especially the gas combustion device with plural stoves 70 having inner orifices 71 and outer orifices 72 supplying gas separately) safer and more convenient.

The preferred embodiment shown and described is only for illustrating the present invention, and not for giving any limitation to the scope of the present invention; it will be apparent to those skilled in this art that various modifications or changes without departing from the spirit of this invention shall also fall within the scope of the appended claims.

1. A flow control valve for a gas combustion device, said flow control valve comprises:
a main-valve plug rod driven by a driving set and a connecting member for displacing linearly;
a main-valve plug provided at a middle section of said main-valve plug rod;
a conical flow adjusting stick provided on a front end of said main-valve plug rod and is synchronically displaced linearly with said main-valve plug rod, and
a valve main-body which is provided with a main valve port having a sealing function in opposition to and in cooperation with said main-valve plug on said main-valve plug rod to form functions of sealing and opening said main valve port;
said main valve port is provided at a location downstream of it with two sections of space having therebetween a section difference, an end of an outlet of said two sections of space is a flow control hole with a smaller caliber, said flow control hole is in opposition to and in cooperation with said flow adjusting stick on said main-valve plug rod to provide a flow limiting function that adjusts flow to said end of said outlet; a small flow complementing hole further is provided in said two sections of space having therebetween said section difference to be in communication with said flow control hole, and by adjusting with a micro-adjusting screw, different amounts are complemented for said flow control hole.

2. The flow control valve for a gas combustion device as in claim 1, wherein said driving set has a motor and a gearing mechanism, and is kept an airtight separation state from said valve main-body.

3. The flow control valve for a gas combustion device as in claim 1, wherein said valve main-body is provided with a communication hole to allow communication of gas for combustion with the outside of said valve main-body.

4. The flow control valve for a gas combustion device as in claim 1, wherein said flow adjusting stick is fixed on said main-valve plug rod with screws and nuts, so that said flow adjusting stick is adapted to being adjusted on its acting distance from said flow control hole to do adjustment according to requirement of gas for combustion.

5. The flow control valve for a gas combustion device as in claim 1, wherein said connecting member is a link rotating by moving of said driving set, said link is screw connected with said main-valve plug rod; and said main-valve plug rod cooperates with said valve main-body in a mode of being guided for to and fro moving without rotating; thereby, when said link is rotated, said main-valve plug rod does linear displacement in said valve main-body.

6. The flow control valve for a gas combustion device as in claim 1, wherein said connecting member is an electromagnetic linkage driven by said driving set, said electromagnetic linkage includes an acting rod moved by said driving set for rotation, an electromagnetic disk screw connecting with said acting rod and displacing linearly to and fro, and an induction disk provided in opposition to said electromagnetic disk is influenced by said electromagnetic disk to generate linear displacement, said induction disk has a pusher rod in connecting with said main-valve plug rod to make said main-valve plug rod displace linearly in said valve main-body.

7. The flow control valve for a gas combustion device as in claim 2, said flow control valve is characterized in that: said gearing mechanism of said driving set further includes a clutch which has an active wheel, a passive wheel and a friction rubber member provided between said active wheel and said passive wheel; when a downstream load is smaller than a friction force of said friction rubber member, said active wheel moves said passive wheel for synchronic rotation, but when said load is larger than said friction force, said active wheel slides away from said passive wheel.

8. The flow control valve for a gas combustion device as in claim 1, wherein said main-valve plug rod is provided with a position detecting magnetic stone, said valve main-body is provided at a position in opposition to that of said position detecting magnetic stone with a displacement detecting element to detect a relative position of said position detecting magnetic stone to obtain displacement of said main-valve plug rod and a state of opening/closing of said main valve port.

9. The flow control valve for a gas combustion device as in claim 1, wherein said main-valve plug rod is provided with a speed detecting magnetic stone, said valve main-body is provided at a position in opposition to that of said speed detecting magnetic stone with a rotating rate detecting element to detect rotating frequency of said connecting member driven by said driving set.

10. The flow control valve for a gas combustion device as in claim 1, wherein said main-valve plug rod is provided outside of said main valve port with a diversion chamber having a plurality of diversion holes with different diameters; said flow adjusting stick is provided on its front end with a plurality of diversion control plugs mating with said diversion holes, said diversion control plugs and their corresponding ones of said diversion holes have their respective set distances in order that said diversion holes have different closing and opening times when said flow adjusting stick displaces linearly, and a minimum flow hole is provided on a valve plug-axle of said diversion control plugs to keep a flame un-extinguished.

11. The flow control valve for a gas combustion device as in claim 10, wherein a front diversion chamber is provided between said main valve port and said diversion chamber, a second valve port is provided between said front diversion chamber and said diversion chamber, and said diversion control plug is provided thereon with a second valve plug to cooperate with said second valve port to give a function of opening/closing; said front diversion chamber further is provided with a by-pass minimum flow hole to communicate with said diversion chamber, said minimum flow hole is provided thereon with a second micro-adjusting screw for adjusting flow in order that gas for combustion flows out from said minimum flow hole, and said gas for combustion flowing out from said minimum flow hole is supplied through a normally opening diversion hole for said gas combustion device for prime combustion.
